(19) United States
(12) Patent Application Publication
(10) Pub. No.: US 2011/0062271 A1
(43) Pub. Date: Mar. 17, 2011

(54) RECORDING MEDIUM FEEDING DEVICE

(75) Inventor: Kenji YANAGISHITA, Matsumoto-shi (JP)

(73) Assignee: SEIKO EPSON CORPORATION, Tokyo (JP)

(21) Appl. No.: 12/882,345

(22) Filed: Sep. 15, 2010

(30) Foreign Application Priority Data
Sep. 16, 2009 (JP) 2009-214323

(51) Int. Cl. B41J 15/04; B65H 16/10; B65H 18/08; B65H 23/06; B41J 15/16

(52) U.S. Cl. 242/390.2

(57) ABSTRACT

A recording medium feeding device feeding by a feeding roller a recording medium which is wound in a roll form and supported by a support axis, includes, a motor that generates a driving force, a driving force transmission section that enables the support axis to rotate by transmitting the driving force to the support axis, and a rotational resistance changing section that changes a rotational resistance given to the support axis, wherein the driving force transmission section includes a driving force changing section that changes a transmission state where the driving force is transmitted to the support axis and a non-transmission state where the driving force is not transmitted to the support axis, by changing a rotational direction of the motor, and wherein the rotational resistance changing section includes a torque limiter connected to or released from the support axis by the change of the motor's rotational direction.

### BACKGROUND

1. Technical Field

The present invention relates to a recording medium feeding device.

2. Related Art

In the related art, there is known a paper feeding device which prevents bending of roll paper caused by the inertial rotation of a roll paper axis (for example, refer to JP-A-2001-163495). In addition, there is known a paper feeding method and a paper feeding device which give an optimum back tension to each paper even when the kinds of paper are changed (for example, refer to JP-A-2004-291395).

The paper feeding device disclosed in JP-A-2001-163495 is provided with an embedded torque limiter at an end portion of the support axis for supporting the roll paper. For this reason, if a rotational resistance given to the support axis is to be changed, there is need to change the support axis or to remove and exchange the torque limiter. Therefore, there is a problem in that upon feeding, winding, or printing the recording medium or the like, an appropriate rotational resistance cannot be given to the support axis according to changes in the situation.

Further, the paper feeding device disclosed in JP-A-2004-291395, which has the configuration where a plurality of torque limiters are coupled to or decoupled from each other by operation of a lever, can change the rotational resistance given to the support axis for supporting the roll paper based on the kinds of roll paper. However, this configuration has a problem in that except for the case of printing, such as feeding, winding the recording medium, or the like, it cannot deal with the change of rotational resistance. Further, there is a problem in that the coupling and the decoupling of the plurality of torque limiters are required to be performed manually.

### SUMMARY

An advantage of some aspects of the invention is to provide a recording medium feeding device capable of giving an appropriate rotational resistance to a support axis for supporting a recording medium according to a change of situation, and of automatically performing the change of rotational resistance given to the support axis.

According to an aspect of the invention, there is provided a recording medium feeding device feeding by a feeding roller a recording medium which is wound in a roll form and supported by a support axis, including a motor that generates a driving force, a driving force transmission section that enables the support axis to rotate by transmitting the driving force to the support axis, and a rotational resistance changing section that changes a rotational resistance given to the support axis, wherein the driving force transmission section includes a driving force changing section that changes a transmission state where the driving force is transmitted to the support axis and a non-transmission state where the driving force is not transmitted to the support axis, by a change of a rotational direction of the motor, and wherein the rotational resistance changing section includes a torque limiter that is connected to or is released from the support axis by the change of the rotational direction of the motor.

By this configuration, when the driving force changing section causes the driving force transmission section to enter the transmission state by the rotation of the motor, the driving force of the motor is transmitted to the support axis to rotate. At this time, when the rotational resistance changing section connects the torque limiter to the support axis by the rotation of the motor, the torque limiter gives the rotational resistance to the support axis. Thereby, it is possible to prevent idling of the support axis caused by the inertia when the support axis rotates using the driving force of the motor, for example, at the time of winding the recording medium, or the like. Further, the torque limiter does not give the rotational resistance to the support axis when the rotational resistance changing section releases the torque limiter from the support axis by the rotation of the motor. Thereby, the support axis can rotate without being influenced by the torque limiter when the support axis rotates using the driving force of the motor, for example, at the time of winding the recording medium, or the like.

In addition, when the driving force changing section causes the driving force transmission section to enter the non-transmission state by the change of the rotational direction of the motor, the support axis does not rotate irrespective of the driving force of the motor. At this time, when the rotational resistance changing section releases the torque limiter from the support axis by the change of the rotational direction of the motor, the torque limiter does not give the rotational resistance to the support axis. Thereby, when the recording medium is fed using the feeding roller or an external transport device or the like by drawing the recording medium, the support axis rotating by a tension acting on the recording medium rotates in a state of not receiving the rotational resistance from the torque limiter, and thereby the tension acting on the recording medium can be set to an appropriate value. In addition, when the rotational resistance changing section connects the torque limiter to the support axis by the change of the rotational direction of the motor, the torque limiter gives the rotational resistance to the support axis. Thereby, when the recording medium is fed using the feeding roller or is transported using the external transport device or the like by drawing the recording medium, the support axis rotates in a state of receiving the rotational resistance from the torque limiter, and thereby the tension acting on the recording medium can be set to a value suitable for the feeding or transport.

Therefore, according to the invention, it is possible to give an appropriate rotational resistance in accordance with a change of situation to the support axis supporting the recording medium, and to give an appropriate tension to the recording medium. Further, it is possible to automatically change the rotational resistance given to the support axis by the change of the rotational direction of the motor.

In the recording medium feeding device of the invention, it is preferable that the rotational resistance changing section includes a torque limiter rotation section that rotates such that the torque limiter is released from the support axis when the motor stops or rotates in a first direction, and the torque limiter is connected to the support axis when the motor rotates in a second direction reverse to the first direction, and wherein the driving force changing section is provided such that the driving force transmission section enters the transmission state when the motor rotates in the first direction, and the driving force transmission section enters the non-transmission state when the motor stops or rotates in the second direction.

By this configuration, when the motor rotates in the first direction, the driving force transmission section enters the non-transmission state and the torque limiter does not give the rotational resistance. Thereby, when the recording medium is fed using the feeding roller or is transported using an external transport device or the like by drawing the recording medium, the support axis rotates in a state of not receiving the rotational resistance from the torque limiter, and thereby the tension acting on the recording medium can be set to an appropriate value.

Further, when the motor rotates in the second direction, the driving force transmission section enters the transmission state and the torque limiter gives the rotational resistance. Thereby, it is possible to prevent idling of the support axis caused by the inertia when the support axis rotates using the driving force of the motor, for example, at the time of winding the recording medium, or the like.

In the recording medium feeding device of the invention, it is preferable that the torque limiter rotation section has a center gear, and a rotation gear that is formed with the torque limiter as a single body and is provided to rotate with respect to a rotation axis of the center gear, and the torque limiter rotation section rotates such that the rotation gear is released from the support axis when the motor stops or rotates in the first direction, and the rotation gear is connected to the support axis when the motor rotates in the second direction.

By this configuration, when the motor stops or rotates in the first direction, the support axis is released from the rotation gear, and thus the torque limiter does not give the rotational resistance to the support axis. Further, when the motor rotates in the second direction, the support axis is connected to the rotation gear, and thus the torque limiter gives the rotational resistance to the support axis via the rotation gear.

In the recording medium feeding device of the invention, it is preferable that the torque limiter rotation section is a part of the driving force changing section, wherein the center gear is connected to the driving force transmission section so as to transmit the driving force, and wherein the rotation gear is connected to the center gear so as to transmit the driving force, and is provided to transmit the driving force to the support axis by being connected to the support axis.

By this configuration, when the motor stops or rotates in the first direction, the support axis is released from the rotation gear, and thus the driving force of the motor is not transmitted to the support axis.

Further, when the motor rotates in the second direction, the support axis is connected to the rotation gear, the driving force of the motor is transmitted to the support axis via the center gear and the rotation gear, and thus the support axis rotates.

In the recording medium feeding device of the invention, it is preferable that the torque limiter rotation section includes a lock mechanism that maintains a state where a rotation gear is connected to the support axis when the motor stops or rotates in the first direction.

By this configuration, even when the motor stops or rotates in the first direction, the torque limiter can give the rotational resistance to the support axis via the rotation gear. Thus, when the recording medium is fed quickly using the feeding roller or is transported using an external transport device or the like, by drawing the recording medium, the support axis rotates in a state of receiving the rotational resistance by the tension acting on the recording medium, and thereby the tension acting on the recording medium can be set to an appropriate value.

In the recording medium feeding device of the invention, it is preferable that the driving force transmission section is provided to transmit the driving force to the feeding roller or the support axis which thus rotates, and wherein the driving force changing section is provided to transmit the driving force to the feeding roller when the motor rotates in the first direction, and to transmit the driving force to the support axis when the motor rotates in the second direction.

By this configuration, when the motor rotates in the first direction, the driving force changing section changes the transmission path of the driving force in the driving force transmission section such that the driving force of the motor is transmitted to the feeding roller. Thereby, the feeding roller rotates and the recording medium wound in a roll form is fed by the feeding roller. As a result, a tension acts in the direction of the recording medium transported, and the support axis supporting the wound recording medium rotates due to the tension on the recording medium. At this time, the torque limiter of the rotational resistance changing section enters a state of not giving the rotational resistance to the support axis when the motor rotates in the first direction. For this reason, when the recording medium is fed using the feeding roller, the support axis rotating due to the tension acting on the recording medium can rotate in a state of not receiving the rotational resistance from the torque limiter. Accordingly, an appropriate tension according to the feeding of the recording medium can be given.

When the motor rotates in the second direction, the driving force changing section changes the transmission path of the driving force in the driving force transmission section such that the driving force of the motor is transmitted to the support axis. Thereby, the support axis rotates and the recording medium is wound. At this time, the torque limiter of the rotational resistance changing section enters a state of giving the rotational resistance to the support axis when the motor rotates in the second direction. As a result, when the support axis rotates to wind the recording medium, it is possible to prevent idling of the support axis caused by the inertia.

In the recording medium feeding device of the invention, it is preferable that the driving force changing section has an outer wheel meshing with a driving axis gear provided at a driving axis of the motor; a sun gear disposed at a rotation center of the outer wheel and connected to the outer wheel so as to rotate along with the outer wheel as a single body; an epicyclic gear train including a plurality of epicyclic gears disposed around the sun gear inside the outer wheel, meshing with the sun gear, and connected to the sun gear so as to rotate as a single body in a rotational direction of the sun gear, and wherein the epicyclic gear train is provided such that the plurality of epicyclic gears rotate when the motor rotates in the first direction, and a first epicyclic gear of the plurality of epicyclic gears meshes with a feeding roller gear transmitting the driving force to the feeding roller of the driving force transmission section, and is provided such that the plurality of epicyclic gears rotate when the motor rotates in the second direction, and the first epicyclic gear stops meshing with the feeding roller gear.

By this configuration, the driving force changing section can connect the first epicyclic gear to the feeding roller gear when the motor rotates in the first direction. Thereby, the driving force of the motor can be transmitted to the feeding roller via the driving axis gear, the outer wheel, the sun gear, the first epicyclic gear, and the feeding roller gear.

Further, the driving force changing section can release the first epicyclic gear from the feeding roller gear when the motor rotates in the second direction. Thereby, it is possible to stop the transmission of the driving force between the motor and the feeding roller and to separate the driving of the motor from the rotation of the feeding roller.

In the recording medium feeding device of the invention, it is preferable that a driven roller that pinches the recording medium along with the feeding roller, and a driven roller movement section that is driven by the epicyclic gear train and thus moves the driven roller to a pinched position close to the feeding roller or an open position spaced apart from the feeding roller, wherein the driven roller movement section has a driven roller holder rotatably supporting the driven roller; an eccentric cam moving the driven roller to the pinched position and the open position by moving the driven roller holder; an eccentric cam gear provided at a rotation axis of the eccentric cam; and a compound gear including a cam driving gear meshing with the eccentric cam gear between a first part gear and a second part gear which are provided at different angle ranges, and wherein the epicyclic gear train is provided such that the plurality of epicyclic gears rotate when the motor rotates in the first direction, and a second epicyclic gear of the plurality of epicyclic gears meshes with the first part gear, and the epicyclic gear train is provided such that the plurality of epicyclic gears rotate when the motor rotates in the second direction, and a third epicyclic gear of the plurality of epicyclic gears meshes with the second part gear.

By this configuration, when the motor rotates in the first direction, the second epicyclic gear meshes with the first part gear of the compound gear. Thereby, the driving force of the motor is transmitted to the compound gear from the second epicyclic gear, and the compound gear rotates in an angle range where the first part gear is formed. As a result, the driving force is transmitted to the eccentric cam gear meshing with the cam driving gear of the compound gear, and the eccentric cam gear rotates in a predetermined angle range corresponding to a rotational angle range of the compound gear. Thus, a rotation axis of the eccentric cam provided with the eccentric cam gear rotates in a predetermined angle range, and the eccentric cam rotates in a predetermined angle range. This moves the driven roller holder and thus the driven roller is moved to the pinched position. At this time, the driving force of the motor is transmitted to the feeding roller via the driving force transmission section by the driving force changing section, and the feeding roller thus rotates. For this reason, the recording medium can be fed by the rotation of the feeding roller, in a state of being pinched between the driven roller and the feeding roller.

Further, the third epicyclic gear meshes with the second part gear of the compound gear when the motor rotates in the second direction. Thereby, the driving force of the motor is transmitted to the compound gear from the third epicyclic gear, and the compound gear rotates in an angle range where the second part gear is formed. The rotational direction of the compound gear at this time is reverse to the rotation of the motor in the first direction. For this reason, by the rotation of the compound gear, the eccentric cam and the rotation axis of the eccentric cam rotate in a predetermined angle range reversely to the rotational direction due to the rotation of the motor in the first direction. As a result, the driven roller holder is moved and thus the driven roller is moved to the open position. At this time, the transmission of the driving force of the motor to the feeding roller is stopped by the driving force changing section, and the driving force of the motor is transmitted to the support axis via the driving force transmission section. Accordingly, when the support axis rotates to wind the recording medium, the recording medium can be wound in an open state of not being pinched between the driven roller and the feeding roller.

In the recording medium feeding device of the invention, it is preferable that a fixed torque limiter gear train that is always connected to the support axis and gives a rotational resistance to the support axis is provided, wherein the rotational resistance given by the fixed torque limiter gear train is smaller than the rotational resistance given by the rotational resistance changing section.

By this configuration, both the rotational resistance changing section and the fixed torque limiter gear train can give the rotational resistance to the support axis, or only the fixed torque limiter gear train can give the rotational resistance to the support axis. Therefore, it is possible to always give the rotational resistance to the support axis, and further to change the magnitude of the rotational resistance given to the support axis according to a change of situation.

### BRIEF DESCRIPTION OF THE DRAWINGS

The invention will be described with reference to the accompanying drawings, wherein like numbers reference like elements.

FIG. 1 is a side view illustrating a paper feeding state in a paper feeding device according to an embodiment of the invention.

FIG. 2 is a side view illustrating a winding state in the paper feeding device in FIG. 1.

FIG. 3 is a side view illustrating a low tension printing state in the paper feeding device in FIG. 1.

FIG. 4 is a side view illustrating a high tension printing state in the paper feeding device in FIG. 1.

FIGS. 5A and 5B are perspective views of a driven roller movement section when seen from the front side, wherein FIG. 5A illustrates an open state and FIG. 5B illustrates a pinched state.

FIGS. 6A and 6B are diagrams when seen from the arrows VIA and VIB shown in FIG. 5A, respectively.

FIGS. 7A and 7B are perspective views of the driven roller movement section when seen from the rear side, wherein FIG. 7A illustrates the open state and FIG. 7B illustrates the pinched state.

FIG. 8 is a perspective view illustrating a driving force transmission section, a driving force changing section, and a rotational resistance changing section of the paper feeding device shown in FIG. 1.

FIG. 9 is an expanded perspective view illustrating the paper feeding device in the paper feeding state shown in FIG. 1.

FIG. 10 is an expanded perspective view illustrating the paper feeding device in the winding state shown in FIG. 2.

FIG. 11 is an expanded perspective view illustrating the paper feeding device in the high tension printing state shown in FIG. 4.

### DESCRIPTION OF EXEMPLARY EMBODIMENTS

Hereinafter, embodiments of the invention will be described with reference to the accompanying drawings.

A paper feeding device in this embodiment is a device which feeds a recording medium such as recording paper which is wound in a roll form, to a printing device. The paper feeding device in this embodiment can automatically change states such as a paper feeding state where recording paper is fed, a winding state where the recording paper is wound, a low tension printing state where a relatively small tension is given to the recording paper at the time of printing, and a high tension printing state where a relatively large tension is given to the recording paper at the time of printing, etc.

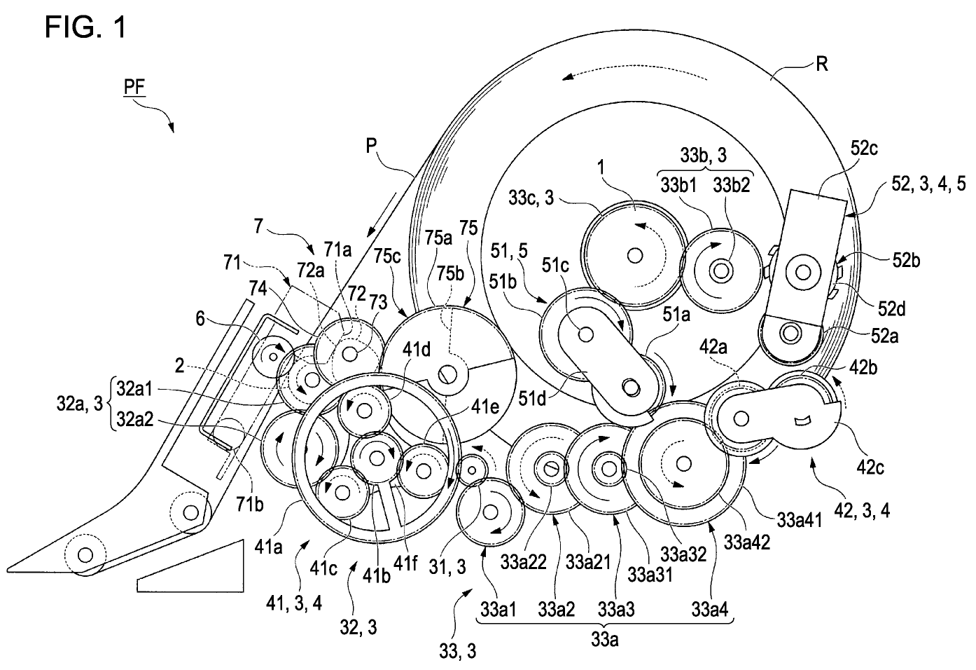

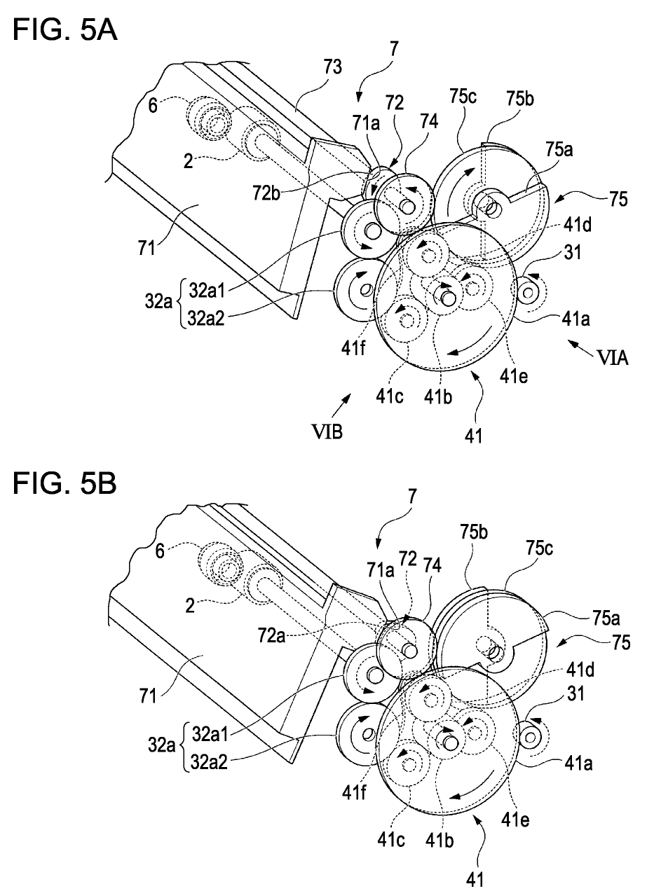

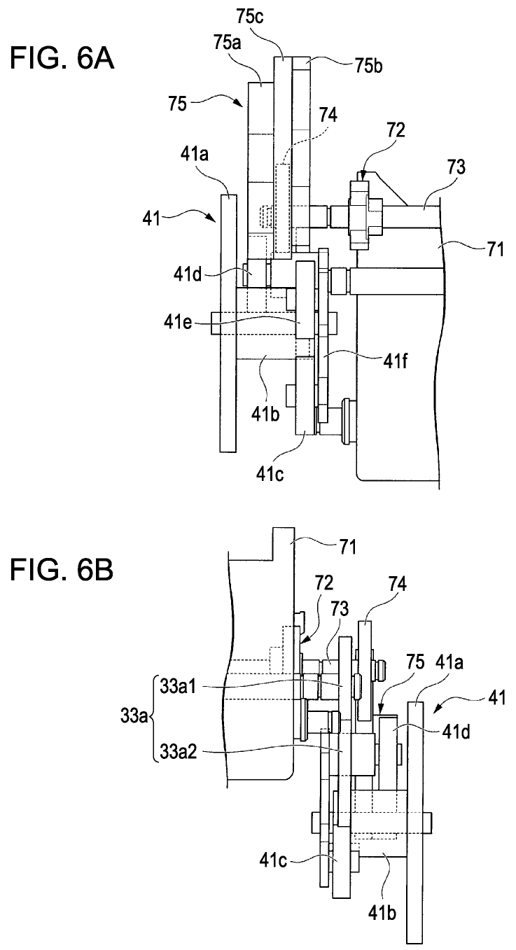

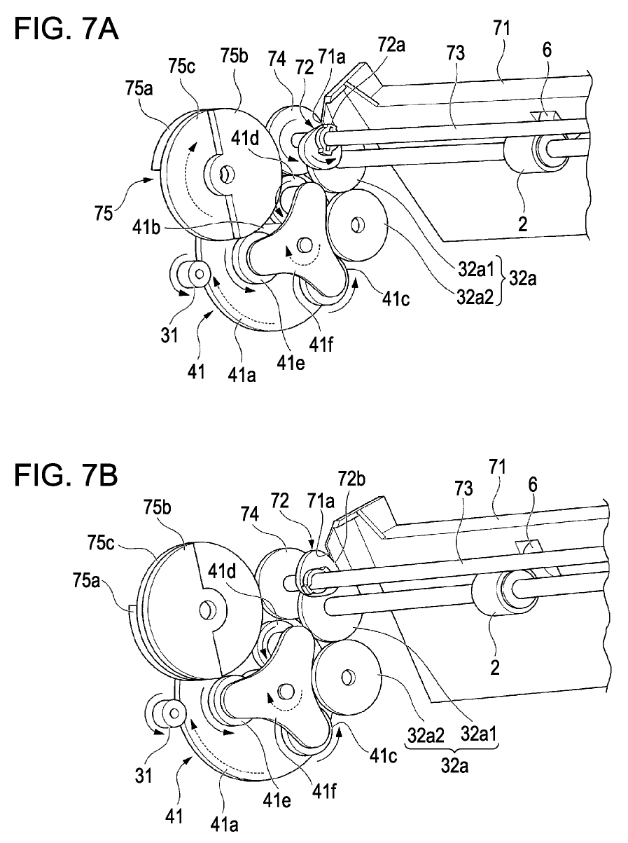

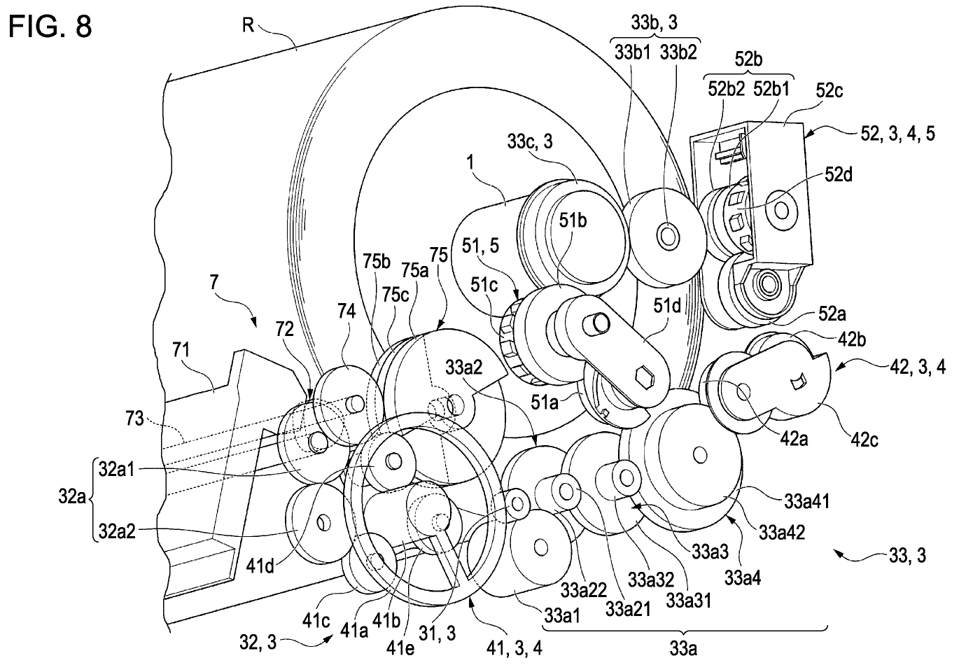

FIGS. 1 to 4 are side views illustrating the paper feeding state, the winding state, the low tension printing state, and the high tension printing state in the paper feeding device PF according to this embodiment, respectively. FIGS. 5A and 5B are expanded perspective views of a driven roller movement section 7 when seen from the front side, wherein FIG. 5A illustrates an open state and FIG. 5B illustrates a pinched state. FIGS. 6A and 6B are diagrams when seen from the arrows VIA and VIB shown in FIG. 5A, respectively. FIGS. 7A and 7B are expanded perspective views of the driven roller movement section 7 when seen from the rear side, wherein FIG. 7A illustrates the pinched state and FIG. 7B illustrates the open state. FIG. 8 is a perspective view illustrating a driving force transmission section 3, a driving force changing section 4, and a rotational resistance changing section 5 of the paper feeding device PF in the paper feeding state.

As shown in FIGS. 1 to 8, the paper feeding device (recording medium feeding device) PF includes a support axis 1 which rotatably supports a roll R of recording paper (recording medium) P wound in a roll form, and a feeding roller 2 which feeds the recording paper P drawn out from the roll R to a printing device (not shown) placed in the lower stream of the paper feeding device PF.

In addition, the paper feeding device PF is provided with a motor (not shown) and includes a driving force transmission section 3 which transmits a driving force from the motor to the feeding roller 2 or the support axis 1 so that one of the two is selectively and rotatably driven, and a driving force changing section 4 which can change by the driving force transmission section 3 the transmission of the driving force to the support axis 1 and the transmission of the driving force to the paper feeding roller 2.

The paper feeding device PF also includes a rotational resistance changing section 5 which can change a limitation state where the rotational resistance is given to the support axis 1 and an open state where the rotational resistance is not given to the support axis 1.

The paper feeding device PF also includes a driven roller 6 which rotates by pinching the recording paper P along with the paper feeding roller 2, and a driven roller movement section 7 which moves the driven roller 6 to a pinched position close to the paper feeding roller 2 or to an open position spaced apart from the paper feeding roller 2.

The driving force transmission section 3 has a driving axis gear 31 fixed to the driving axis of the motor, a feeding roller driving gear train 32 provided in the paper feeding roller 2 side of the driving axis gear 31, and a support axis driving gear train 33 provided in the support axis 1 side of the driving axis gear 31.

The rotational resistance changing section 5 has a first torque limiter epicyclic gear train 51, and a second torque limiter epicyclic gear train (torque limiter rotation section) 52 included in the support axis driving gear train 33.

The driving force changing section 4 has a triple epicyclic gear train (epicyclic gear train) 41 included in the feeding roller driving gear train 32, a connection epicyclic gear train 42 included in the support axis driving gear train 33, and the second torque limiter epicyclic gear train 52 included in the support axis driving gear train 33 and the rotational resistance changing section 5.

The driven roller movement section 7 has a driven roller holder 71 which rotatably supports the driven roller 6, an eccentric cam 72 which moves the driven roller holder 71, a rotation axis 73 of the eccentric cam 72, an eccentric cam gear 74 provided at the rotation axis 73, and a compound gear 75 connected to the eccentric cam gear 74.

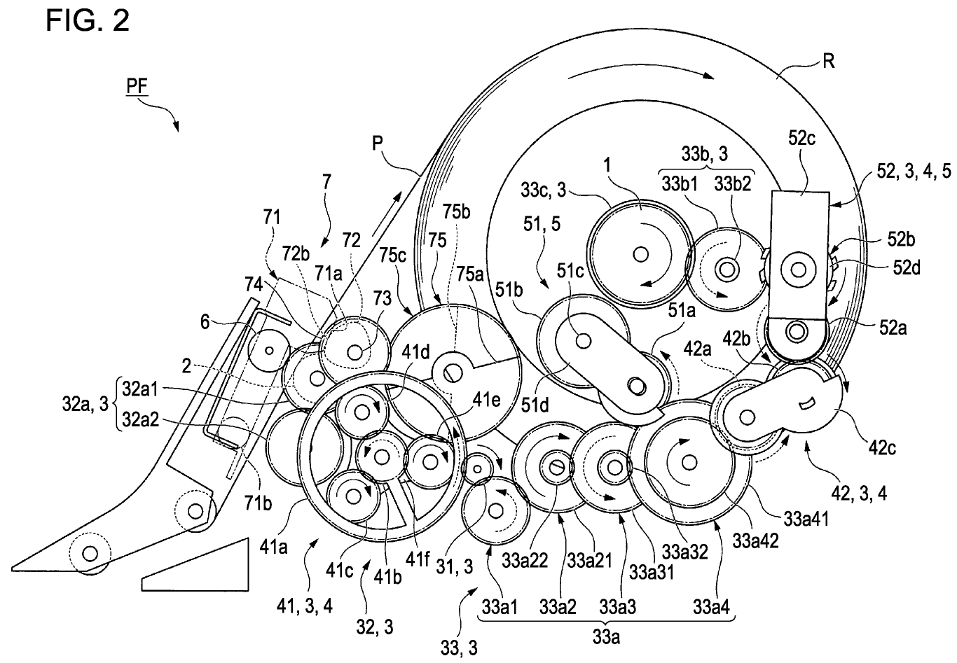

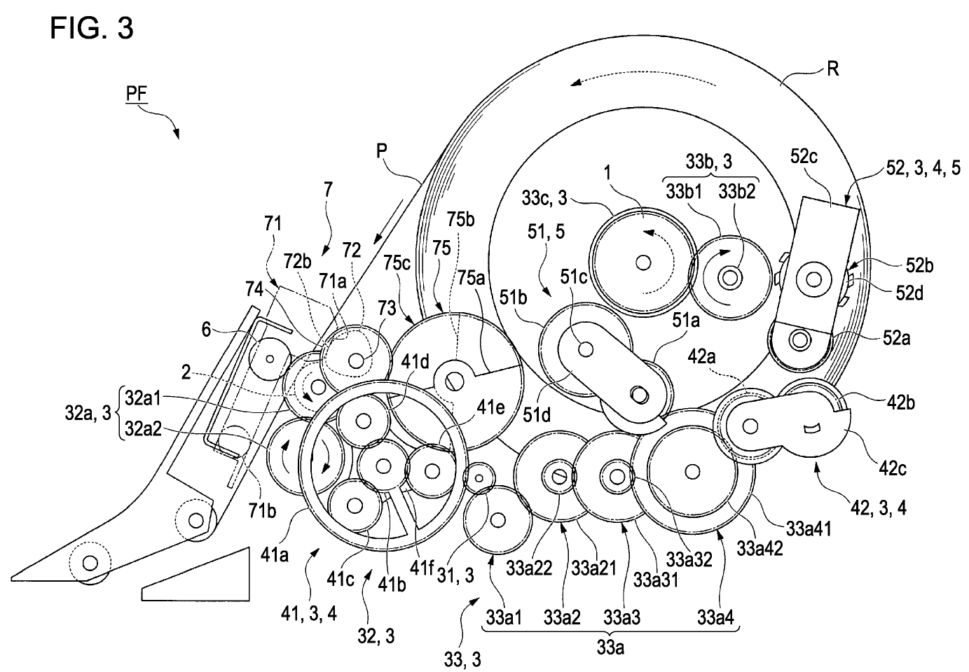

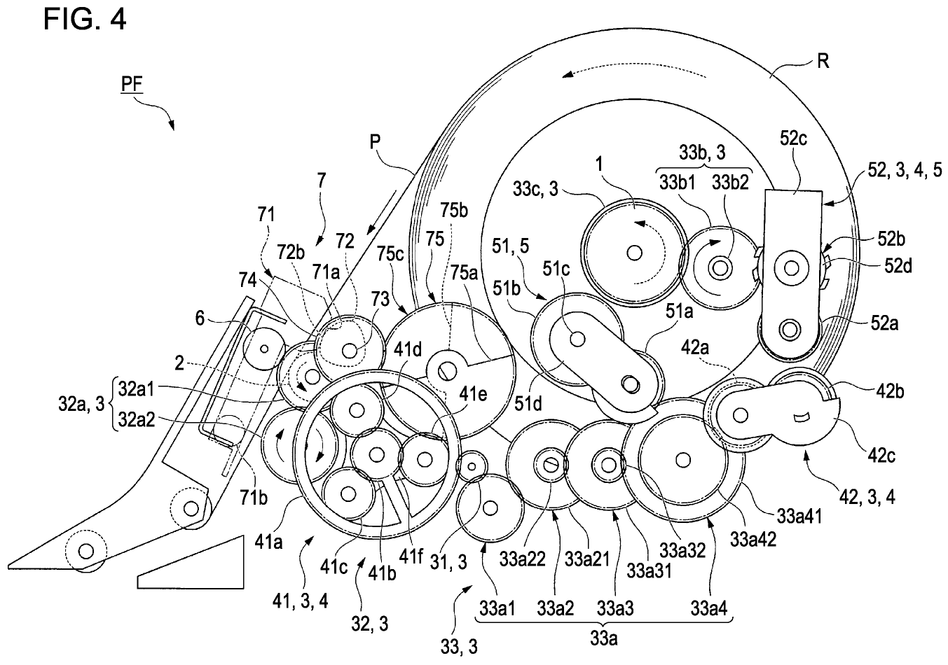

The driving axis gear 31 constituting the driving force transmission section 3 rotates in the paper feeding state shown in FIG. 1 in the counterclockwise (hereinafter, referred to as “CCW”) direction by a normal rotation (rotation in a first direction) of the motor (not shown) when seen from the front side. Further, the driving axis gear 31 rotates in the winding state shown in FIG. 2 in the clockwise (hereinafter, referred to as “CW”) direction by a reverse rotation (rotation in a second direction) of the motor (not shown) when seen from the front side. The driving axis gear 31 stops in the low tension printing state shown in FIG. 3 and the high tension printing state shown in FIG. 4. In addition, in FIGS. 1 to 5, and FIG. 7, the rotation in the CW direction (hereinafter, also referred to as “CW rotation”) in each gear is marked with the solid arrow and the rotation in the CCW direction (hereinafter, also referred to as “CCW rotation”) in each gear is marked with the broken arrow.

The feeding roller driving gear train 32 constituting the driving force transmission section 3 has the triple epicyclic gear train 41 connected to the driving axis gear 31, and a feeding roller gear train 32a connected to the triple epicyclic gear train 41. The feeding roller gear train 32a has a first feeding roller gear 32a1 provided at a rotation axis of the feeding roller 2, and a second feeding roller gear 32a2 connected to the first feeding roller gear 32a1.

The support axis driving gear train 33 constituting the driving force transmission section 3 has a driving force transmission gear train 33a connected to the driving axis gear 31, the connection epicyclic gear train 42 connected to the driving force transmission gear train 33a, the second torque limiter epicyclic gear train 52 driven by the connection epicyclic gear train 42, a low resistance torque limiter gear train (fixed torque limiter gear train) 33b driven by the second torque limiter epicyclic gear train 52, and a support axis gear 33c provided at the support axis 1.

The low resistance torque limiter gear train 33b constituting the support axis driving gear train 33 of the driving force transmission section 3 has a low resistance torque limiter gear 33b1 which meshes with and is always connected to the support axis gear 33c, and a low resistance torque limiter 33b2 coupled to the low resistance torque limiter gear 33b1 as a single body. The low resistance torque limiter 33b2 is provided to give rotational resistance of, for example, about 300 gf·cm when the low resistance torque limiter gear 33b1 rotates in the CW direction and CCW direction. The low resistance torque limiter 33b2 may be, for example, of a mechanical type or a fluid type.

The first torque limiter epicyclic gear train 51 constituting the rotational resistance changing section 5 has a sun gear 51a connected to the driving force transmission gear train 33a of the driving force transmission section 3, an epicyclic gear 51b which does not mesh with and is thus not connected to the sun gear 51a, a first high resistance torque limiter 51c formed with the epicyclic gear 51b as a single body, and a holder 51d which supports a rotation axis of the epicyclic gear 51b and at the same time rotatably supports the epicyclic gear 51b with respect to a rotation axis of the sun gear 51a.

The first high resistance torque limiter 51c is provided to give rotational resistance at the time of rotation of the epicyclic gear 51b. Further, the rotational resistance given by the first high resistance torque limiter 51c is about 1 kgf·cm, which is greater than the rotational resistance given by the low resistance torque limiter 33b2. The first high resistance torque limiter 51c may be, for example, of a mechanical type or a fluid type.

The first torque limiter epicyclic gear train 51 is disposed to be tilted in the CCW direction with respect to the vertical direction in the rotatable range. For this reason, the first torque limiter epicyclic gear train 51 is maximally tilted in the CCW direction due to the gravity acting thereon when the holder 51d is not biased in the CW direction by the CW rotation of the sun gear 51a. The first torque limiter epicyclic gear train 51 enables the epicyclic gear 51b and the support axis gear 33c to become spaced apart from each other so as to release each other when the holder 51d shown in FIGS. 2 to 4 is maximally tilted in the CCW direction.

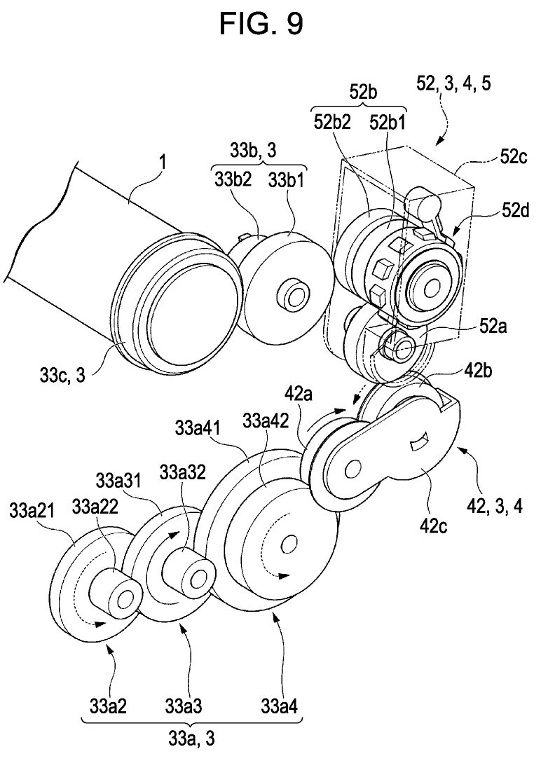

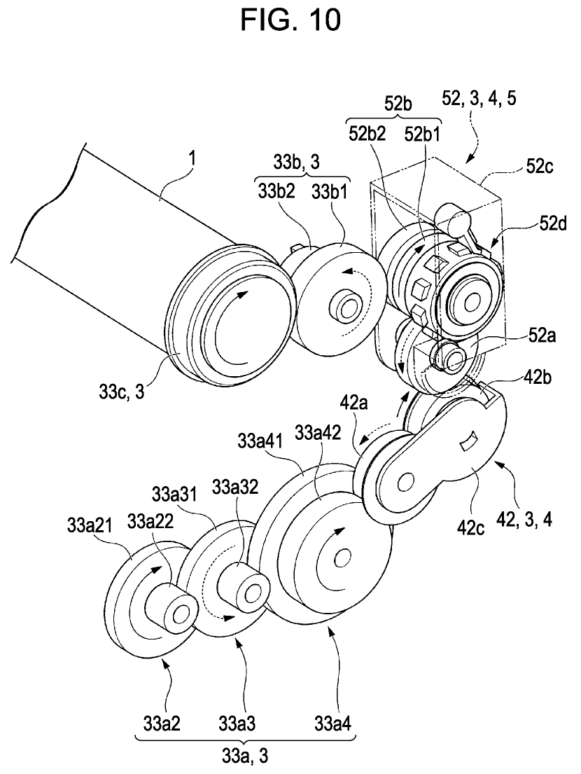

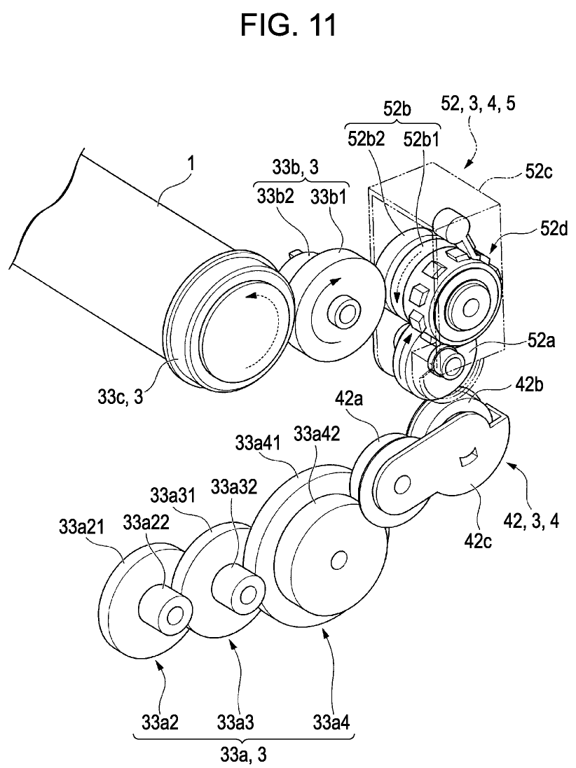

FIG. 9 is an expanded perspective view illustrating the vicinity of the connection epicyclic gear train 42 and the second torque limiter epicyclic gear train 52 in the paper feeding state shown in FIG. 1. FIG. 10 is an expanded perspective view illustrating the vicinity of the connection epicyclic gear train 42 and the second torque limiter epicyclic gear train 52 in the winding state shown in FIG. 2. FIG. 11 is an expanded perspective view illustrating the vicinity of the connection epicyclic gear train 42 and the second torque limiter epicyclic gear train 52 in the high tension printing state shown in FIG. 4. In FIGS. 9 to 11, the first torque limiter epicyclic gear train 51 is not shown.

As shown in FIGS. 9 to 11, the connection epicyclic gear train 42, which constitutes the support axis driving gear train 33 of the driving force transmission section 3 and the driving force changing section 4, has a sun gear 42a connected to the driving force transmission gear train 33a, an epicyclic gear 42b which meshes with and is thus connected to the sun gear 42a, and a holder 42c which supports a rotation axis of the epicyclic gear 42b and at the same time rotatably supports the epicyclic gear 42b with respect to a rotation axis of the sun gear 42a.

As shown in FIGS. 1 to 4, the connection epicyclic gear train 42 is disposed to be tilted in the CW direction with respect to the vertical direction in the rotatable range. For this reason, as shown in FIGS. 1, 3 and 4, the connection epicyclic gear train 42 is maximally tilted in the CW direction due to the gravity acting thereon when the holder 42c is not biased in the CCW direction by the CCW rotation of the sun gear 42a. The connection epicyclic gear train 42 enables the epicyclic gear 42b and a sun gear 52a of the second torque limiter epicyclic gear train 52 to become spaced apart from each other so as to release each other when the holder 42c is maximally tilted in the CCW direction.

As shown in FIGS. 9 to 11, the second torque limiter epicyclic gear train 52, which constitutes the support axis driving gear train 33 of the driving force transmission section 3, the driving force changing section 4, and the rotational resistance changing section 5, has the sun gear 52a (center gear) provided to mesh with the epicyclic gear 42b of the connection epicyclic gear train 42, an epicyclic gear (rotation gear) 52b which meshes with and is connected to the sun gear 52a, a holder 52c which supports a rotation axis of the epicyclic gear 52b and at the same time rotatably supports the epicyclic gear 52b with respect to a rotation axis of the sun gear 52a, and a second high resistance torque limiter (torque limiter) 52d formed with the epicyclic gear 52b as a single body.

The second high resistance torque limiter 52d is provided to give rotational resistance of, for example, 1 kgf·cm at the time of rotation of the epicyclic gear 52b. In addition, the rotational resistance given by the second high resistance torque limiter 52d is greater than the rotational resistance given by the low resistance torque limiter 33b2. The second high resistance torque limiter 52d may be, for example, of a mechanical type shown in FIGS. 9 to 11, or a fluid type, or the like.

As shown in FIGS. 8 to 11, the epicyclic gear 52b of the second torque limiter epicyclic gear train 52 has a first outer gear 52b1 meshing with an outer gear of the sun gear 52a and a second outer gear 52b2 provided to mesh with the low resistance torque limiter gear 33b1 of the low resistance torque limiter gear train 33b, which are adjacent to each other in the direction of the rotation axis. That is to say, the epicyclic gear 52b of the second torque limiter epicyclic gear train 52 is provided to transmit the driving force transmitted from the sun gear 52a to the support axis 1 by connection to the support axis gear 33c via the low resistance torque limiter gear 33b1.

In addition, as shown in FIGS. 1 to 4, the second torque limiter epicyclic gear train 52 is disposed to be tilted in the CW direction with respect to the vertical direction in the rotatable range. For this reason, the holder 52c is maximally tilted in the CW direction due to the gravity acting on the holder 52c when the holder 52c is not biased in the CCW direction by the CCW rotation of the sun gear. The second torque limiter epicyclic gear train 52 enables the epicyclic gear 52b and the low resistance torque limiter gear 33b1 to become spaced apart from each other so as to released each other when the holder 52c is maximally tilted in the CCW direction.

The second torque limiter epicyclic gear train 52 is provided with a lock mechanism (not shown) using, for example, a solenoid driving or a latch cam mechanism. The lock mechanism works in a state where the holder 52c rotates in a rotational direction of the sun gear 52a and thereby can fix the holder 52c in the state.

The driven roller holder 71 constituting the driven roller movement section 7 is a frame-shaped member which rotatably supports the driven roller 6, and has a contact section 71a having contact with an outer edge of the eccentric cam 72. The driven roller holder 71 is provided to rotate with respect to a rotatably moving axis 71b.

The eccentric cam 72 is fixed to a rotation axis 73 and is provided to rotate along with the rotation axis 73 as a single body. The eccentric cam 72 has an oval shape where the diameter is not constant from the center of the rotation axis 73 to the edge and has a minor axis 72a with a short diameter and a major axis 72b with a long diameter. The eccentric cam 72 rotates with respect to the rotation axis 73, and is provided to move the driven roller 6 to the pinched position shown in FIG. 1 and the open position shown in FIG. 2, respectively, by supporting the driven roller holder 71 by means of the minor axis 72a and the major axis 72b.

The compound gear 75, as shown in FIGS. 5 to 7, has a first semiperimeter gear (first part gear) 75a, a cam driving gear 75c, and a second semiperimeter gear (second part gear) 75b, from the front side to the rear side in the direction of the rotation axis. The first semiperimeter gear 75a and the second semiperimeter gear 75b are respectively provided by a half of the compound gear 75 in different angle ranges of the compound gear 75, and form an outer gear in an entire angle range. The cam driving gear 75c placed between the first semiperimeter gear 75a and the second semiperimeter gear 75b has an outer gear through an entire perimeter of the compound gear 75, and meshes with and is connected to the eccentric cam gear 74 provided at the rotation axis 73 of the eccentric cam 72.

The triple epicyclic gear train 41, which constitutes the feeding roller driving gear train 32 of the driving force transmission section 3 and the driving force changing section 4, has an outer wheel 41a, a sun gear 41b, a first epicyclic gear 41c, a second epicyclic gear 41d, and a third epicyclic gear 41e.

The outer wheel 41a of the triple epicyclic gear train 41 is provided with an outer gear meshing with the driving axis gear 31 in the outer perimeter and covers the first epicyclic gear 41c, the second epicyclic gear 41d, and the third epicyclic gear 41e. The sun gear 41b is disposed at the rotation center of the outer wheel 41a. In addition, in FIGS. 1 to 4, and FIG. 8, the outer wheel 41a is partly cut and shown so as to easily see the relationship between these plural gears.

The sun gear 41b of the triple epicyclic gear train 41 is disposed at the rotation center of the outer wheel 41a and is connected to the outer wheel 41a so as to rotate as a single body. The outer perimeter of the sun gear 41b is entirely provided with an outer gear. The sun gear 41b meshes with the first epicyclic gear 41c, the second epicyclic gear 41d, and the third epicyclic gear 41e, which are disposed around the sun gear 41b.

The first epicyclic gear 41c, the second epicyclic gear 41d, and the third epicyclic gear 41e of the triple epicyclic gear train 41 are uniformly disposed in the direction of the perimeter of the sun gear 41b inside the outer wheel 41a. Outer gears formed in the entire outer perimeters of the respective first to third epicyclic gears 41c to 41e mesh with the outer gear of the sun gear 41b. In addition, the first to third epicyclic gears 41c to 41e are connected to one another by being respectively rotatably supported by a rotation axis of a connection member 41f.

The connection member 41f of the triple epicyclic gear train 41 is a member having a round and nearly triangular plate shape, and three vertices thereof are provided with the respective rotation axes of the first to third epicyclic gears 41c to 41e. The center of connection member 41f is slidably supported by the rotation axis of the sun gear 41b, and is provided to rotate in the rotational direction of the sun gear 41b. The connection member 41f rotates in the rotational direction of the sun gear 41b, and thereby the first to third epicyclic gears 41c to 41e rotate as a single body in the rotational direction of the sun gear 41b.

As shown in FIGS. 5 to 7, the first epicyclic gear 41c is provided in the rear side in the direction of the rotation axis when seen from the second epicyclic gear 41d so as to mesh with the second feeding roller gear 32a2 of the feeding roller driving gear train 32. The second epicyclic gear 41d is provided in the front side in the direction of the rotation axis when seen from the first epicyclic gears 41c and the third epicyclic gear 41e so as to mesh with the first semiperimeter gear 75a of the compound gear 75. In addition, the third epicyclic gear 41e is provided in the rear side in the direction of the rotation axis when seen from the second epicyclic gear 41d so as to mesh with the second semiperimeter gear 75b of the compound gear 75.

The driving force transmission gear train 33a constituting the support axis driving gear train 33 of the driving force transmission section 3 has, as shown in FIGS. 1 to 4 and FIG. 8, a first gear 33a1 meshing with the driving axis gear 31, a second gear 33a2 meshing with the first gear 33a1, a third gear 33a3 meshing with the second gear 33a2, and a fourth gear 33a4 meshing with the third gear 33a3. The first gear 33a1 to the fourth gear 33a4 are set to have appropriate outer diameters in consideration of the respective gear ratios or the like.

The second gear 33a2 has an outer perimeter outer gear 33a21 which is provided in the outer perimeter and meshes with the first gear 33a1, and an inner perimeter outer gear 33a22 which is provided in the inner perimeter and meshes with the third gear 33a3. The third gear 33a3 has an outer perimeter outer gear 33a31 which is provided in the outer perimeter and meshes with the inner perimeter outer gear 33a22 of the second gear 33a2, and an inner perimeter outer gear 33a32 which is provided in the inner perimeter and meshes with the fourth gear 33a4. The fourth gear 33a4 has an outer perimeter outer gear 33a41 which is provided in the outer perimeter and meshes with the inner perimeter outer gear 33a32 of the third gear 33a3, and an inner perimeter outer gear 33a42 which is provided in the inner perimeter and meshes with the connection epicyclic gear train 42. The outer perimeter outer gear 33a41 of the fourth gear 33a4 meshes with and is connected to the sun gear 51a of the first torque limiter epicyclic gear train 51. The inner perimeter outer gear 33a42 of the fourth gear 33a4 meshes with and is connected to the sun gear 42a of the connection epicyclic gear train 42.

Next, an operation of the paper feeding device PF in the paper feeding state will be described.

When the motor of the paper feeding device PF rotates normally, as shown in FIG. 1, the driving axis gear 31 rotates in the CCW direction and thus the driving force is transmitted to the outer wheel 41a of the triple epicyclic gear train 41 meshing with the driving axis gear 31. Thereby, the outer wheel 41a rotates in the CW direction, the sun gear 41b formed with the outer wheel 41a as a single body rotates in the CW direction, and the driving force is transmitted from the sun gear 41b to the first to third epicyclic gears 41c to 41e. In addition, the connection member 41f is biased in the CW direction by the CW rotation of the sun gear 41b.

In turn, the first to third epicyclic gears 41c to 41e rotate in the CCW direction (rotation) and at the same time rotate in the CW direction as a single body with respect to the rotation axis of the sun gear 41b (revolution). Further, the first epicyclic gear 41c is connected to and meshes with the second feeding roller gear 32a2 of the feeding roller gear train 32a. Thereby, the driving force is transmitted from the first epicyclic gear 41c to the second feeding roller gear 32a2 so as to enable the second feeding roller gear 32a2 to rotate in the CW direction. Thus, the driving force is transmitted to the first feeding roller gear 32a1 meshing with the second feeding roller gear 32a2, the first feeding roller gear 32a1 rotates in the CCW direction along with the rotation axis, and thus the feeding roller 2 rotates in the CCW direction.

In this way, the triple epicyclic gear train 41, which constitutes the driving force changing section 4 and the driving force transmission section 3, is provided to transmit, by the normal rotation of the motor, the driving force of the motor to the feeding roller 2 via the driving axis gear 31 and the feeding roller gear train 32a which constitute the driving force transmission section 3.

In addition, as shown in FIG. 1, when the driving axis gear 31 rotates in the CCW direction by the normal rotation of the motor, the driving force of the motor is sequentially transmitted from the first gear 33a1 to the fourth gear 33a4 of the driving force transmission gear train 33a. Thereby, the first gear 33a1 rotates in the CW direction, the second gear 33a2 rotates in the CCW direction, the third gear 33a3 rotates in the CW direction, and the fourth gear 33a4 rotates in the CCW direction. In turn, as shown in FIG. 9, the sun gear 42a of the connection epicyclic gear train 42 rotates in the CW direction due to the driving force transmitted from the fourth gear 33a4, and the epicyclic gear 42b rotates in the CCW direction. In addition, the holder 42c of the connection epicyclic gear train 42 is biased in the CW direction by the CW rotation of the sun gear 42a, and the epicyclic gear 42b rotates in the CW direction with respect to the rotation axis of the sun gear 42a (revolution).

Thereby, the epicyclic gear 42b of the connection epicyclic gear train 42 and the sun gear 52a of the second torque limiter epicyclic gear train 52 stop meshing with each other and are thus released from each other, so the driving force of the motor is not transmitted between these gears. Therefore, in the normal rotation of the motor, the driving force of the motor enters a state of not being transmitted to the support axis 1 (non-transmission state).

Further, in the state where the driving force of the motor is not transmitted to the sun gear 52a of the second torque limiter epicyclic gear train 52, as shown in FIGS. 1 and 9, the second torque limiter epicyclic gear train 52 enters an open state where the connection thereof to the support axis 1 via the epicyclic gear 52b and the low resistance torque limiter gear 33b1 by the gravity acting on the holder 52c is stopped. In other words, the second torque limiter epicyclic gear train 52 rotates so as to released the second high resistance torque limiter 52d from the support axis 1 by the normal rotation of the motor.

As such, the connection epicyclic gear train 42 and the second torque limiter epicyclic gear train 52, constituting the driving force changing section 4 and the driving force transmission section 3, are provided, by the normal rotation of the motor, to stop the transmission of the driving force of the motor between the connection epicyclic gear train 42 and the second torque limiter epicyclic gear train 52, and between the second torque limiter epicyclic gear train 52 and the low resistance torque limiter gear train 33b.

In addition, when the fourth gear 33a4 of the driving force transmission gear train 33a rotates in the CCW direction, the sun gear 51a of the first torque limiter epicyclic gear train 51 rotates in the CW direction due to the driving force transmitted from the fourth gear 33a4. In turn, the holder 51d is biased in the CW direction, and the epicyclic gear 51b meshes with and is connected to the support axis gear 33c. Thereby, during the rotation, the support axis 1 enters a limitation state where the rotational resistance is given thereto by the first high resistance torque limiter 51c. Here, the epicyclic gear 51b does not mesh with and is thus released from the sun gear 51a, so it does not receive the driving force from the sun gear 51a, and this causes the epicyclic gear 51b to rotate independently from the sun gear 51a.

In addition, as shown in FIG. 2, in the open state where the driven roller 6 and the feeding roller 2 are spaced apart from each other, the major axis 72b of the eccentric cam 72 has contact with the contact section 71a of the driven roller holder 71. When the motor rotates normally and the driving axis gear 31 rotates in the CCW direction in this state, as shown FIG. 5A, the outer wheel 41a and the sun gear 41b of the triple epicyclic gear train 41 rotate in the CW direction, and the first to third epicyclic gears 41c to 41e rotate in the CCW direction. In addition, the connection member 41f is biased to the CW direction due to the CW rotation of the sun gear 41b, and thereby the first to third epicyclic gears 41c to 41e rotate in the CW direction as a single body.

Subsequently, as shown in FIG. 6A, the third epicyclic gear 41e and the second semiperimeter gear 75b of the compound gear 75 are released to be spaced apart from each other, and, as shown in FIG. 6B, the first epicyclic gear 41c meshes with and is connected to the second feeding roller gear 32a2. Thereby, as shown in FIG. 5A, the second feeding roller gear 32a2 rotates in the CW direction, the first feeding roller gear 32a1 rotates in the CCW direction, and the feeding roller 2 rotates in the CCW direction.

Further, as shown in FIG. 5A, the second epicyclic gear 41d meshes with and is connected to the first semiperimeter gear 75a placed in the lower side of the compound gear 75. In turn, the driving force of the motor is transmitted from the second epicyclic gear 41d to the first semiperimeter gear 75a and thus the compound gear 75 rotates in the CW direction. Subsequently, the driving force is transmitted to the eccentric cam gear 74 meshing with and connected to the cam driving gear 75c of the compound gear 75, the eccentric cam gear 74 rotates in the CCW direction, and the eccentric cam 72 rotates in the CCW direction.

When the compound gear 75 rotates in the CW direction by about 180° in the state shown in FIG. 5A, the first semiperimeter gear 75a is positioned at the upper side as shown in FIG. 5B. Thereby, the first semiperimeter gear 75a and the second epicyclic gear 41d stop meshing with each other and thus the compound gear 75 stops rotating. Thus, the eccentric cam 72 stops in a state where the minor axis 72a has contact with the contact section 71a of the driven roller holder 71. The driven roller holder 71 is moved from the position shown in FIG. 5A to the position shown in FIG. 5B by the rotation of the eccentric cam 72, and the driven roller 6 is disposed at the pinched position where the recording paper P can be pinched between the driven roller 6 and the feeding roller 2.

Thereby, as shown in FIG. 1, the recording paper P is fed in the feeding direction in the pinched state between the driven roller 6 and the feeding roller 2 by the CCW rotation of the feeding roller 2. At this time, the driven roller 6 rotates in the CW direction by following the feeding of the recording paper P. When the recording paper P is fed in the feeding direction, a tension is generated in the recording paper P between the feeding roller 2 and the roll R. Thereby, the tension in the recording paper P acts on the outer perimeter of the roll R, a torque acts on the support axis 1 supporting the roll R, and the support axis 1 rotates in the CCW direction. In turn, the support axis gear 33c provided at the support axis 1 rotates in the CCW direction, and the epicyclic gear 51b of the first torque limiter epicyclic gear train 51 connected to the support axis gear 33c rotates in the CW direction.

At this time, the rotational resistance is given to the epicyclic gear 51b by the first high resistance torque limiter 51c of the first torque limiter epicyclic gear train 51, and thus the rotational resistance by the first high resistance torque limiter 51c is given to the support axis gear 33c from the epicyclic gear 51b. Accordingly, it is possible to give a relatively large rotational resistance of, for example, about 1 kgf·cm to the support axis 1 as compared with the case where the rotational resistance is given by only the low resistance torque limiter 33b2, and thus to give a high tension to the recording paper P. Thereby, at the time of feeding the recording paper P by the feeding roller 2, it is possible to give an appropriate tension to the recording paper P and reduce a skew of the recording paper P.

In addition, the support axis 1 rotates in the CCW direction in a state of also receiving the rotational resistance from the low resistance torque limiter 33b2 via the low resistance torque limiter gear 33b1. However, since the rotational resistance given to the support axis 1 by the first high resistance torque limiter 51c is greater than that given to the support axis 1 by the low resistance torque limiter 33b2, the rotational resistance by the first high resistance torque limiter 51c is dominant.

Next, an operation of the paper feeding device PF in the winding state will be described.

When the motor rotates reversely in the paper feeding device PF, as shown in FIG. 2, the driving axis gear 31 rotates in the CW direction to transmit the driving force to the outer wheel 41a of the triple epicyclic gear train 41 meshing with the driving axis gear 31, and thereby the outer wheel 41a and the sun gear 41b rotate in the CCW direction. In turn, the driving force is transmitted from the sun gear 41b to the first to third epicyclic gears 41c to 41e, and the connection member 41f is biased in the CCW direction by the CCW rotation of the sun gear 41b.

Thereby, the first to third epicyclic gear 41c to 41e rotate in the CW direction (rotation) and at the same time rotate in the CCW direction as a single body (revolution). Subsequently, the first epicyclic gear 41c and the second feeding roller gear 32a2 stop meshing with and are released from each other. Thus, the transmission of the driving force of the motor is stopped between the first epicyclic gear 41c and the second feeding roller gear 32a2.

As such, the triple epicyclic gear train 41 constituting the driving force changing section 4 is provided, by the reverse rotation of the motor, to stop the transmission of the driving force of the motor to the feeding roller 2 between the triple epicyclic gear train 41 and the second feeding roller gear 32a2 constituting the driving force transmission section 3.

In addition, when the driving axis gear 31 rotates in the CW direction due to the reverse rotation of the motor, as shown in FIG. 2, the first gear 33a1 of the driving force transmission gear train 33a rotates in the CCW direction, the second gear 33a2 rotates in the CW direction, the third gear 33a3 rotates in the CCW direction, and the fourth gear 33a4 rotates in the CW direction. Thereby, as shown in FIG. 10, the sun gear 42a of the connection epicyclic gear train 42 rotates in the CCW direction and the epicyclic gear 42b rotates in the CW direction (rotation), by the driving force transmitted from the fourth gear 33a4. Further, the holder 42c of the connection epicyclic gear train 42 is biased in the CCW direction by the CCW rotation of the sun gear 42a, and the epicyclic gear 42b rotates in the CCW direction (revolution) with respect to the rotation axis of the sun gear 42a.

As a result, the epicyclic gear 42b of the connection epicyclic gear train 42 and the sun gear 52a of the second torque limiter epicyclic gear train 52 mesh with and are connected to each other, and the driving force of the motor enters a state of being transmitted between these gears. Thereby, the driving force is transmitted from the epicyclic gear 42b of the connection epicyclic gear train 42 to the sun gear 52a of the second torque limiter epicyclic gear train 52 to rotate in the CCW direction, and the epicyclic gear 52b rotates in the CW direction. At this time, the rotational resistance is given to the epicyclic gear 52b from the second high resistance torque limiter 52d.

In addition, the holder 52c of the second torque limiter epicyclic gear train 52 is biased in the CCW direction by the CCW rotation of the sun gear 52a, and the epicyclic gear 52b rotates in the CCW direction with respect to the rotation axis of the sun gear 52a. Thereby, the epicyclic gear 52b of the second torque limiter epicyclic gear train 52 and the low resistance torque limiter gear 33b1 of the low resistance torque limiter gear train 33b mesh with and are connected to each other. As a result, the driving force of the motor is transmitted to the low resistance torque limiter gear 33b1 which thus rotates in the CCW direction. The low resistance torque limiter gear 33b1 causes the support axis gear 33c to rotate in the CW direction in the state of receiving the rotational resistance from the low resistance torque limiter 33b2, and in turn the support axis 1 to rotate in the CW direction. Thereby, the roll R rotates in the CW direction and the recording paper P is wound.

As such, the connection epicyclic gear train 42 and the second torque limiter epicyclic gear train 52 constituting the driving force transmission section 3 and the driving force changing section 4 are provided, by the reverse rotation of the motor, to transmit the driving force of the motor to the support axis 1 via the driving axis gear 31, the driving force transmission gear train 33a, the low resistance torque limiter gear train 33b, and the support axis gear 33c, which constitute the driving force transmission section 3. In other words, the connection epicyclic gear train 42 and the second torque limiter epicyclic gear train 52 are provided to change the transmission state where the driving force of the motor is transmitted to the support axis 1 and the non-transmission state where it is not transmitted thereto by the change of the rotational direction of the motor.

The second high resistance torque limiter 52d is connected, by the reverse rotation of the motor, to the support axis 1 via the epicyclic gear 52b of the second torque limiter epicyclic gear train 52 and the low resistance torque limiter gear 33b1. Thereby, the support axis 1 enters a limitation state where the rotational resistance is given thereto by the second high resistance torque limiter 52d. In other words, the second torque limiter epicyclic gear train 52 constituting the rotational resistance changing section 5 is provided, by the change of the rotational direction of the motor, to connect the second high resistance torque limiter 52d to the support axis 1 via the low resistance torque limiter gear 33b1, or release it from the support axis 1.

When the fourth gear 33a4 of the driving force transmission gear train 33a rotates in the CW direction, the sun gear 51a of the first torque limiter epicyclic gear train 51 rotates in the CCW direction due to the driving force transmitted from the fourth gear 33a4. As a result, the holder 51d is biased in the rotational direction of the sun gear 51a which thus rotates in the CCW direction, and the epicyclic gear 51b and the support axis gear 33c stop meshing with and are released from each other. Thereby, the support axis 1 is released from the first high resistance torque limiter 51c, and the support axis 1 enters an open state where the rotational resistance is not given by the first high resistance torque limiter 51c during rotation.

Also, as shown in FIG. 1, in the pinched state where the driven roller 6 and the feeding roller 2 are close to each other and thus can pinch the recording paper P, the minor axis 72a of the eccentric cam 72 has contact with the contact section 71a of the driven roller holder 71. In this state, when, due to the reverse rotation of the motor, the driving axis gear 31 rotates in the CW direction when seen from the front side as shown in FIG. 7A, the outer wheel 41a and the sun gear 41b of the triple epicyclic gear train 41 rotate in the CCW direction when seen from the front side, and the first to third epicyclic gears 41c to 41e rotate in the CW direction when seen from the front side. Further, the connection member 41f is biased in the CCW direction when seen from the front side by the CW rotation of the sun gear 41b, and this causes the first to third epicyclic gears 41c to 41e to rotate in the CW direction as a single body when seen from the front side.

Thereby, the first epicyclic gear 41c and the second feeding roller gear 33a2 become spaced apart from each other, and thus the second feeding roller gear 33a2 and the first feeding roller gear 33a1 stop rotating. As a result, the feeding roller 2 stops. In addition, the second epicyclic gear 41d and the first semiperimeter gear 75a of the compound gear 75 are released and spaced apart from each other.

As shown in FIG. 7A, the third epicyclic gear 41e meshes with and is connected to the second semiperimeter gear 75b positioned at about a half of the right when seen from the rear side of the compound gear 75. Thereby, the driving force of the motor is transmitted from the third epicyclic gear 41e to the second semiperimeter gear 75b, and the compound gear 75 rotates in the CCW direction when seen from the front side. Thus, the driving force is transmitted to the eccentric cam gear 74 meshing with and connected to the cam driving gear 75c of the compound gear 75, the eccentric cam gear 74 rotates in the CW direction when seen from the front side, and the eccentric cam 72 rotates in the CW direction when seen from the front side.

The compound gear 75 rotates by about 180° in the CCW direction when seen from the front side, from the state shown in FIG. 7A, and thereby, as shown in FIG. 7B, the second semiperimeter gear 75b is positioned at about a half of the left when seen from the rear side of the compound gear 75. As a result, the second semiperimeter gear 75b and the third epicyclic gear 41e stop meshing with each other, and the compound gear 75 stops rotating. The eccentric cam 72 stops in the state where the major axis 72b has contact with the contact section 71a of the driven roller holder 71. The driven roller holder 71 is moved from the position shown in FIG. 7A to the position shown in FIG. 7B, by the rotation of the eccentric cam 72, and the driven roller 6 is disposed at the open position of being spaced apart from the feeding roller 2.

Thereby, as shown in FIG. 2, the recording paper P is wound on the roll R by the CW rotation of the support axis 1 in the state of not being pinched between the driven roller 6 and the feeding roller 2. At this time, as shown in FIG. 10, the second high resistance torque limiter 52d is connected to the support axis 1 via the low resistance torque limiter gear 33b1 and the epicyclic gear 52b of the second torque limiter epicyclic gear train 52. Thus, at the time of winding the recording paper P, it is possible to give a relatively high rotational resistance of, for example, about 1 kgf·cm to the support axis 1. Accordingly, it is possible to wind the recording paper P while preventing idling caused by the inertia of the support axis 1.

Next, the paper feeding device PF in the low tension printing state shown in FIG. 3 will be described.

In order to transfer the paper feeding device PF to the low tension printing state, for example, the motor rotates reversely, and the motor stops after passing through the winding state shown in FIG. 2. Thereby, as shown in FIG. 3, the driving axis gear 31 and the first to fourth gears 33a1 to 33a4 of the driving force transmission gear train 33a stop, and the sun gear 51a of the first torque limiter epicyclic gear train 51 and the sun gear 42a of the connection epicyclic gear train 42 stop, which are connected to the fourth gear 33a4.

Since the first torque limiter epicyclic gear train 51 is disposed to be tilted in the CCW direction with respect to the vertical direction in the rotatable range, the gravity acts on the holder 51d in the CCW direction. For this reason, the first torque limiter epicyclic gear train 51 does not rotate in the CW direction in the state shown in FIG. 2 in the winding state shown in FIG. 2 even when the sun gear 51a stops and thereby the biasing force to the holder 51d in the CW direction disappears, and it maintains the open state where the support axis gear 33c and the epicyclic gear 51b are spaced apart from each other as shown in FIG. 3.

Since the connection epicyclic gear train 42 is disposed to be tilted in the CW direction with respect to the vertical direction in the rotatable range, the gravity acts on the holder 42c in the CW direction. For this reason, the connection epicyclic gear train 42 rotates in the CW direction by the gravity acting on the holder 42c in the winding state shown in FIG. 2 when the sun gear 42a stops, and thereby the biasing force to the holder 42c in the CCW direction disappears. Therefore, as shown in FIG. 3, the epicyclic gear 42b of the connection epicyclic gear train 42 and the sun gear 52a of the second torque limiter epicyclic gear train 52 stop meshing with and are released from each other, so the transmission of the driving force is stopped between these gears. As a result, the sun gear 52a of the second torque limiter epicyclic gear train 52 stops.

Since the second torque limiter epicyclic gear train 52 is disposed to be tilted in the CW direction with respect to the vertical direction in the rotatable range, the gravity acts on the holder 52c in the CW direction. For this reason, the second torque limiter epicyclic gear train 52 rotates in the CW direction by the gravity acting on the holder 52c in the winding state shown in FIG. 2 when the sun gear 52a stops, and thereby the biasing force to the holder 52c in the CCW direction disappears. Therefore, as shown in FIG. 3, the epicyclic gear 52b of the second torque limiter epicyclic gear train 52 and the low resistance torque limiter gear 33b1 stop meshing with and are released from each other.

As a result, the rotational resistance by the second high resistance torque limiter 52d of the second torque limiter epicyclic gear train 52 is not transmitted to the support axis 1 via the low resistance torque limiter gear 33b1.

Accordingly, the support axis 1 enters the open state of not receiving the rotational resistance from the first high resistance torque limiter 51c and the second high resistance torque limiter 52d of the rotational resistance changing section 5 and receives only the rotational resistance from the low resistance torque limiter 33b2.

When the motor stops through the winding state shown in FIG. 2, the driving axis gear 31 stops, and the outer wheel 41a and the sun gear 41b of the triple epicyclic gear train 41 also stop. Thereby, as shown in FIG. 3, the compound gear 75 and the eccentric cam gear 74 remain still, and the driven roller holder 71 maintains the state where the contact section 71a has contact with the major axis 72b of the eccentric cam 72. Thus, the driven roller 6 is disposed at the open position, and the recording paper P maintains the state of not being pinched between the driven roller 6 and the feeding roller 2.

When the recording paper P is transported to the printing device (not shown) placed in the lower stream in the feeding direction of the recording paper P of the paper feeding device PF, a tension acts on the recording paper P, the tension acting on the recording paper P acts on the outer perimeter of the roll R, and a torque acts on the support axis 1 supporting the roll R. Thereby, as shown in FIG. 3, the support axis 1 rotates in the CCW direction to draw the recording paper P from the roll R, and the recording paper P is fed to the printing device (not shown) from the paper feeding device PF. At this time, a relatively small rotational resistance of, for example, about 300 gf·cm by the low resistance torque limiter 33b2 is given to the support axis 1 via the low resistance torque limiter gear 33b1 and the support axis gear 33c. Therefore, the paper feeding device PF can give a relatively small tension to the recording paper P in the low tension printing state shown in FIG. 3.

Next, the paper feeding device PF in the high tension printing state shown in FIG. 4 will be described.

Transfer to the high tension printing state of the paper feeding device PF may be performed using almost the same order as the transfer to the low tension printing state described above. The transfer to the high tension printing state is different from the transfer to the low tension printing state in that the lock mechanism of the second torque limiter epicyclic gear train 52 works before the motor stops in the winding state shown in FIG. 2. The remainder is the same as the transfer to the low tension printing state and thus the description of the same portions will be omitted.

In order to transfer the paper feeding device PF to the high tension printing device shown in FIG. 4, the lock mechanism of the second torque limiter epicyclic gear train 52 works in the winding state shown in FIG. 2, and thereafter the motor stops. Thereby, as shown in FIGS. 4 and 11, the driving axis gear 31 and the first to fourth gears 33a1 to 33a4 of the driving force transmission gear train 33a stop, and the sun gear 51a of the first torque limiter epicyclic gear train 51 and the sun gear 42a of the connection epicyclic gear train 42 stop, which are connected to the fourth gear 33a4.

As a result, as shown in FIG. 4, the first torque limiter epicyclic gear train 51 maintains the open state where the support axis gear 33c and the epicyclic gear 51b are spaced apart from each other in the same manner as the transfer to the low tension printing state. In addition, as shown in FIG. 11, the connection epicyclic gear train 42 also rotates in the CW direction due to the gravity in the CW direction acting on the holder 42c in the same manner as the transfer to the low tension printing state. Further, the epicyclic gear 42b of the connection epicyclic gear train 42 and the sun gear 52a of the second torque limiter epicyclic gear train 52 stop meshing with and are released from each other. Thereby, the sun gear 52a of the second torque limiter epicyclic gear train 52 stops.

Here, since the holder 52c is fixed due to the working of the lock mechanism, the second torque limiter epicyclic gear train 52 does not rotate in the CW direction even when the gravity acts on the holder 52c in the CW direction, and maintains the state where the epicyclic gear 52b and the low resistance torque limiter gear 33b1 mesh with and are connected to each other.

Thus, the rotational resistance by the second high resistance torque limiter 52d of the second torque limiter epicyclic gear train 52 is transmitted to the support axis 1 via the low resistance torque limiter gear 33b1.

Accordingly, the support axis 1 enters the limitation state of receiving the rotational resistance from the second high resistance torque limiter 52d of the second torque limiter epicyclic gear train 52 constituting the rotational resistance changing section 5. Here, the rotational resistance by the low resistance torque limiter 33b2 is given to the support axis 1 via the low resistance torque limiter gear 33b1 and the support axis gear 33c, but the influence of the second high resistance torque limiter 52d to the support axis 1 giving the rotational resistance greater than that is dominant.

In addition, when the motor stops after passing through the winding state shown in FIG. 2, in the same manner as the transfer to the low tension printing state, the driven roller holder 71 maintains the state where the contact section 71a has contact with the major axis 72b of the eccentric cam 72. Thereby, the driven roller 6 is disposed at the open position, and the recording paper P maintains the state of not being pinched between the driven roller 6 and the feeding roller 2.

In this state, when the recording paper P is transported to the printing device (not shown) placed in the lower stream in the feeding direction of the recording paper P of the paper feeding device PF, a tension acts on the recording paper P, the tension acting on the recording paper P acts on the outer perimeter of the roll R, and a torque acts on the support axis 1 supporting the roll R. Thereby, as shown in FIG. 4, the support axis 1 rotates in the CCW direction to draw the recording paper P from the roll R, and the recording paper P is fed to the printing device (not shown) from the paper feeding device PF. At this time, a relatively large rotational resistance of, for example, about 1 kgf·cm by the second high resistance torque limiter 52d is given to the support axis 1 via the epicyclic gear 52b of the second torque limiter epicyclic gear train 52, the low resistance torque limiter gear 33b1, and the support axis gear 33c. Therefore, the paper feeding device PF can give, in the high tension printing state shown in FIG. 4, the tension greater than that in the low tension printing state to the recording paper P.

As described above, according to the paper feeding device PF in this embodiment, it is possible to give the appropriate rotational resistance in accordance with the change of situation to the support axis 1 supporting the roll R of the recording paper P, and to automatically change the rotational resistance given to the support axis 1.

In addition, it is possible to rapidly perform the stopping of the transmission of the driving force of the motor to the support axis by including the connection epicyclic gear train 42, as the driving force changing section 4, which is greater than the second torque limiter epicyclic gear train 52 in the tilted angle with respect to the vertical direction and is faster than the second torque limiter epicyclic gear train 52 in the rotational speed at the time of stopping the transmission of the driving force.

The invention is not limited to the embodiment described above, but various modifications can be made without departing from the spirit and scope of the invention. For example, the second torque limiter may be a one-way direction torque limiter which limits a rotational torque of any one of the CW rotation and the CCW rotation of the epicyclic gear (rotation gear) of the second torque limiter epicyclic gear train. In this case, it is possible to prevent the rotational idling caused by the inertia of the support axis by controlling the current of the motor. In addition, after the motor rotates reversely, if the motor rotates normally in a state where the lock mechanism works, the second high resistance torque limiter can be connected to the support axis even when the motor rotates normally.

What is claimed is:

1. A recording medium feeding device feeding by a feeding roller a recording medium which is wound in a roll form and supported by a support axis, comprising:
a motor that generates a driving force;
a driving force transmission section that enables the support axis to rotate by transmitting the driving force to the support axis; and
a rotational resistance changing section that changes a rotational resistance given to the support axis,
wherein the driving force transmission section includes a driving force changing section that changes a transmission state where the driving force is transmitted to the support axis and a non-transmission state where the driving force is not transmitted to the support axis, by a change of a rotational direction of the motor, and
wherein the rotational resistance changing section includes a torque limiter that is connected to or is released from the support axis by the change of the rotational direction of the motor.

2. The recording medium feeding device according to claim 1, wherein the rotational resistance changing section includes a torque limiter rotation section that rotates such that the torque limiter is released from the support axis when the motor stops or rotates in a first direction, and the torque limiter is connected to the support axis when the motor rotates in a second direction reverse to the first direction, and
wherein the driving force changing section is provided such that the driving force transmission section enters the transmission state when the motor rotates in the first direction, and the driving force transmission section enters the non-transmission state when the motor stops or rotates in the second direction.

3. The recording medium feeding device according to claim 2, wherein the torque limiter rotation section has a center gear, and a rotation gear that is formed with the torque limiter as a single body and is provided to rotate with respect to a rotation axis of the center gear, and the torque limiter rotation section rotates such that the rotation gear is released from the support axis when the motor stops or rotates in the first direction, and the rotation gear is connected to the support axis when the motor rotates in the second direction.

4. The recording medium feeding device according to claim 3, wherein the torque limiter rotation section is a part of the driving force changing section,
wherein the center gear is connected to the driving force transmission section so as to transmit the driving force, and
wherein the rotation gear is connected to the center gear so as to transmit the driving force, and is provided to transmit the driving force to the support axis by being connected to the support axis.

5. The recording medium feeding device according to claim 2, wherein the torque limiter rotation section includes a lock mechanism that maintains a state where a rotation gear is connected to the support axis when the motor stops or rotates in the first direction.

6. The recording medium feeding device according to claim 2, wherein the driving force transmission section is provided to transmit the driving force to the feeding roller or the support axis which thus rotates, and
wherein the driving force changing section is provided to transmit the driving force to the feeding roller when the motor rotates in the first direction, and to transmit the driving force to the support axis when the motor rotates in the second direction.

7. The recording medium feeding device according to claim 1, wherein the driving force changing section has an outer wheel meshing with a driving axis gear provided at a driving axis of the motor; a sun gear disposed at a rotation center of the outer wheel and connected to the outer wheel so as to rotate along with the outer wheel as a single body; an epicyclic gear train including a plurality of epicyclic gears disposed around the sun gear inside the outer wheel, meshing with the sun gear, and connected to the sun gear so as to rotate as a single body in a rotational direction of the sun gear, and
wherein the epicyclic gear train is provided such that the plurality of epicyclic gears rotate when the motor rotates in the first direction, and a first epicyclic gear of the plurality of epicyclic gears meshes with a feeding roller gear transmitting the driving force to the feeding roller of the driving force transmission section, and is provided such that the plurality of epicyclic gears rotate when the motor rotates in the second direction, and the first epicyclic gear stops meshing with the feeding roller gear.

8. The recording medium feeding device according to claim 7, further comprising:
a driven roller that pinches the recording medium along with the feeding roller; and
a driven roller movement section that is driven by the epicyclic gear train and thus moves the driven roller to a pinched position close to the feeding roller or an open position spaced apart from the feeding roller,
wherein the driven roller movement section has a driven roller holder rotatably supporting the driven roller; an eccentric cam moving the driven roller to the pinched position and the open position by moving the driven roller holder; an eccentric cam gear provided at a rotation axis of the eccentric cam; and a compound gear including a cam driving gear meshing with the eccentric cam gear between a first part gear and a second part gear which are provided at different angle ranges, and
wherein the epicyclic gear train is provided such that the plurality of epicyclic gears rotate when the motor rotates in the first direction, and a second epicyclic gear of the plurality of epicyclic gears meshes with the first part gear, and the epicyclic gear train is provided such that the plurality of epicyclic gears rotate when the motor rotates in the second direction, and a third epicyclic gear of the plurality of epicyclic gears meshes with the second part gear.

9. The recording medium feeding device according to claim 1, further comprising a fixed torque limiter gear train that is always connected to the support axis and gives a rotational resistance to the support axis,
wherein the rotational resistance given by the fixed torque limiter gear train is smaller than the rotational resistance given by the rotational resistance changing section.
